(19) United States
(12) Patent Application Publication
(10) Pub. No.: US 2015/0254238 A1
(43) Pub. Date: Sep. 10, 2015

(54) System and Methods for Maintaining Speech-To-Speech Translation in the Field

(71) Applicant: Facebook, Inc., Menlo Park, CA (US)

(72) Inventors: Alexander Waibel, Murrysville, PA (US); Ian R. Lane, Moffet Field, CA (US)

(21) Appl. No.: 14/722,013

(22) Filed: May 26, 2015

Related U.S. Application Data
(63) Continuation-in-part of application No. 12/689,042, filed on Jan. 18, 2010, now Pat. No. 9,070,363.
Application No. 12/689,042 is a continuation-in-part of application No. 11/925,048, filed on Oct. 26, 2007, now Pat. No. 8,090,570.
Application No. 11/925,048 is a continuation-in-part of application No. 12/424,311, filed on Apr. 15, 2009, now Pat. No. 8,204,739.

(51) Int. Cl. G06F 17/28

(52) U.S. Cl. CPC G06F 17/289; G06F 17/2881; G06F 17/2845

(57) ABSTRACT

Extensions to an apparatus for speech translation improve the effectiveness of communication. An apparatus for speech translation capable of repairing errors and expanding its vocabulary. System and methods improve the ease by which common, linguistically untrained users can better recover from errors, extend and customize the language coverage of their speech translation device and increase the speed of effective communication, including stopping translation by shaking, correction of pronunciations using pseudo phonetics, translation favorites, translation modes, small dictionary based on user repair and boosting, single action speech translators, speech translation dialog language learning, translation from telephone conversations, targeted ads based on translated speech, backchanneling based on speech, and web presentation based on speech.

### CROSS REFERENCE TO RELATED APPLICATIONS

The present application is a continuation in part of U.S. Nonprovisional patent application Ser. No. 12/689,042, filed Jan. 18, 2010, allowed, which is a continuation in part of U.S. Nonprovisional patent application Ser. No. 12/424,311 filed on Apr. 15, 2009, now U.S. Pat. No. 8,204,739, issued Jun. 19, 2012, and is a continuation in part of U.S. Nonprovisional patent application Ser. No. 11/925,048 filed on Oct. 26, 2007, now U.S. Pat. No. 8,090,570, issued Jan. 3, 2012, the contents of which are incorporated herein by reference.

### BACKGROUND OF THE INVENTION

1. Field of the Invention

The present invention modified and extends patent filing on “System for Maintaining Speech-to-Speech Translation in the Field” and is directed generally at making speech-to-speech translation systems even more effective and user friendly for cross-lingual communication. More particularly, the extended methods disclosed in this CIP enable nonexpert users to improve and modify the coverage and usage of their system in the field and to maximize the usefulness for effective communication in the field, without requiring linguistic or technical knowledge or expertise.

2. Description of the Invention Background

Speech Translation systems have achieved a level of performance that now makes effective speech translation in broad popular use a reality, and permits its use on small portable platforms such as laptop computers, PDA's and mobile telephones. As such, it is impractical to send speech translation systems back to the developer every time errors occur, vocabulary items are missing. Similarly, field situations dictate, that a user must be able to deal with errors quickly and effectively, and that effective communication is supported through the device, however, imperfect its performance.

### SUMMARY OF THE INVENTION

In the following, we disclose several extensions to an apparatus for speech translation that improve the effectiveness of communication, and we provide a detailed description of their operation. We will make reference to the original patent filing, which describes an apparatus for speech translation capable of repairing errors and expanding its vocabulary. The disclosed methods improve the ease by which common, linguistically untrained users can better recover from errors, extend and customize the language coverage of their speech translation device and increase the speed of effective communication. We propose the following important and novel methods:

1. Speech Translation Quick Stop by Shaking

2. Correction of Pronunciations by way of Pseudo Phonetics

3. Speech Translation Favorites

4. Speech Translation Modes (Rude, Informal, Commanding, Local Dialect, . . . )

5. Smaller Dictionary based on User Repair and Boosting

6. Language identification for Single Action Speech Translators

7. Language Learning based on Speech Translation Dialogs

8. Speech Translation from Telephone Conversation

9. Targeted Ads based on Recognized and Translated Speech.

10. Perfect Listener Backchanneling based on Speech

11. Web Presentation based on Speech

### DETAILED DESCRIPTION

The description of the proposed methods builds on patent filing on Maintaining Speech-to-Speech Translation in the Field.

### Quick Abort

No speech recognition and translation device will ever deliver perfect performance. Thus error handling becomes a critical part of delivering fast and effective speech communication. Errors are problematic only, if they cannot be aborted quickly, corrected quickly and system performance improve (learn) from the correction. A speech translation device performs several tasks in sequence: speech recognition, machine translation, and text-to-speech synthesis in the new target language. Typically each of these steps is handled by system processes responsible for each of these steps. Each of these components can be launched in sequence or are often launched in parallel in a pipelined fashion to save overall processing time. Thus the processes are launched asynchronously in parallel, and often run already before the user actually finishes speaking. If erroneous input is received (a user misspeaks or system components produce erroneous output), a user typically has to wait till the full end-to-end speech translation completed, leading to unnecessary delays and confusion when the translated sentence is non-sensical.

If a user realizes that he has misspoken, or if erroneous word hypotheses emerge from the recognition engine (sometimes incrementally), a user would rather like to quickly stop the entire process and start over, without delay. Traditionally, such aborting action was not possible at all, or if implemented, required keystrokes or mouse clicks that command the system and its components to stop its component processes. In a mobile environment, even such keystrokes and mouse-clicks are bothersome and time consuming, when every second counts to get a point across in a multilingual dialog situation.

In the present invention, we disclose a method to perform this aborting action more swiftly. We introduce into the correction module a abort action, which instantaneously
Aborts the ASR, MT and TTS processes that may already been running
Wipes any hypotheses or partial hypotheses that may have already been output
Resets the system to accept a new input

In our invention, this abort action has to be accepted by a user interface input method that is quick and easy to use and access by the user during dialog. We choose a shake of the wrist as an input action that is swift and effective in a dialog action while holding a speech translation device in the hand, and it avoids any other keyboard or touch screen input.

To capture the wrist action, we use accelerometers that are already provided by some hardware manufacturers. Alternatively, we may use vision based sensing of rapid movement as features to classify an shaking action.

As an alternative aborting action, we may use the record button itself, which immediately terminates all ongoing previous processes and accepts a new input.

### Claims:

Abort speech translation subcomponents altogether with one immediate command
Method to abort speech translation processes with shake of the wrist
Method to abort speech translation processes by pressing the record button
Indicating the aborting action acoustically with a crumbling noise, or other sound icon.

### Correction of Pronunciations by Way of Pseudo Phonetics

We have previously disclosed a method for adding new words to the components of a speech translation device by way of certain word classes that provide a mechanism for adding and subtracting names to a list of words that belong to this class (e.g., city names, person names, etc.). In this disclosure, the system automatically attempts to fill all necessary parametric information for the word so it can be properly recognized, translated and pronounced in its intended context meaning and environment. For this the user selects the word class that the word belongs to (e.g. city name, or person's last name, etc.). The system also automatically produces a phonetic transcriptions of the word that tells the recognition and synthesis modules how the word is pronounced in both of the speech translator's languages. As disclosed previously these automatic phonetic transcriptions are performed by a letter-to-sound transcription module that uses handwritten or automatically learned acoustic-phonetic mapping rules or mapping functions to generate the phonetic string.

For example:

a textual input of the name: “Pittsburgh”

would generate the phonetic string: “P I T S B ER G”

Now, letter-to-sound rules, whether learned or hand-written will never be perfect and may produce errorful transcriptions, particularly when foreign names are pronounced in unusual ways, i.e. in ways that deviate from normal English pronunciation rules.

Example: “Silvio” would be pronounced as “S I L V AY O”

To permit proper handling, therefore, the user should be given the possibility to modify or to correct the phonetic transcription, In our prior disclosure this was done by providing the user with access to the phonetic string as proposed by the automatic letter-to-sound rules, and make it user editable. In this manner, the user could. enter a phonetic transcription of the new desired word by themselves.

Many linguistically untrained users, however, do not know how to write a phonetic transcription in standardized IPA (International Phonetic Alphabet) notation, and thus would not be able to enter new words easily. A more flexible user friendly mechanism is therefore devised that provides a more intuitive method. We insert letter-to-sound conversion and synthesis in the user editable phonetic transcription, thereby enabling the user to enter the phonetic transcript orthographically, that is, as a spelling of that pronunciation. On the User Interface, the user is instructed to enter it under “Pronounced As”. Thus in our example above, the name “Silvio” would be entered listed orthographically as “Silvio” and we may enter it under “Pronounced As” as “S I L V Y O”. Internally then, the letter-to-sound generator produces a phonetic string for this new modified orthography in the hope that it matches the intended phonetic transcription. The user can verify this match intuitively by listening to it. Next to the text string for “Pronounced As”, the user interface provides a play back button, which permits a user to play a synthetic rendering of the modified pseudo phonetic spelling. Internally, this is realized by running the pseudo-phonetic spelling of the name (as entered or edited in the “Pronounced As” field) through the letter-to-sound conversion module which generates the actual phonetic string in IPA (or other standardized phonetic) notation. Subsequently, the speech synthesis module is run to generate the audible synthetic pronunciation of that phonetic string. If the user is not satisfied with the way it sounds, he/she can iterate by modifying the pseudo-phonetic orthographic transcription until the desired pronunciation is achieved. When it is, the systems saves the phonetic transcript obtained in that manner along with the orthographic spelling of the word for the new added word.

### Claims:

Pseudo-Phonetic Entry of Pronunciations for New Names in the Customization Module of a fieldable Speech-to-Speech Translator

### Speech Translation Favorites

Frequently, users may say the same sentence repeatedly in a field situation and it would not be necessary to respeak the same sentences over and over again. We introduce a the concept of a speech translation favorites list, which stores frequently used phrases for rapid play-back. This favorites differs from a plain list or phrase hook in one most important aspect: it gets filled and built by the speech translation device, and thus, does not require a bilingual speaker to be on hand to know the correct translation to a term or phrase. Thus we insert into our fieldable device a favorites module that has the following functions:

1. Copy both a.) original spoken sentence and b.) translation from the speech translation interaction window to a favorites list

2. Provide editing capability to the newly copied bilingual sentence pair, so a user can modify both input and output string

3. Provide the ability to play back the target language side of the added sentence pair by applying the synthesis module

With the favorites list in place, a user can simply play back various accumulated phrases from the favorites list, without speaking them first. This saves time in field situations. At the same time the favorites list provides the full flexibility of a full two-way speech-to-speech translator since it does not require a linguistically trained expert knowledgeable of both languages to build such a list. A customized list can be built by the user in the field and on the fly.

### Claims:

Copy Translations from Speech-to-Speech Translator for rapid deployment phrase generation. Novelty and uniqueness is that the phrases are generated by translator, and thus not preprogrammed but can be customized and prepared by the user. Quick play back of such prepared phrases are faster and allow for rapid play/response in the field.

### Speech Translation Modes

Even when performing speech translation limited to one language pair, there are variations in language use depending on social situation, dialect, regional expression and context that are typically not differenciated by a standardized speech translator. Yet, it is in many ways critically important to separate them to achieve socially appropriate results. Thus, the same user may speak formally in a formal context at work, in an informal colloquial manner at home with his/her family, and use slang at a party with friends. Similarly, there may be situational differences, such as authoritative or submissive speaking, depending on whether the device is used by a police/military officer on duty or as a clerk in a department store.

In addition to language choices, we introduce a language “mode”. This mode operates like a switch that switches the device into the appropriate speaking mode, and modifies/conditions the modeling of several system subcomponents accordingly. Two mechanisms are employed: Filters and Mode-Dependent Models

Filter Method: in this method we use a mode switch only to filter or enable certain recognitions and translations that are otherwise internally processed and understood, but potentially not produced. A case in point for this procedure is a rude/strong language mode which can be enabled or disabled. This is important, so as not to inadvertently produce strong language, when it is not intended, yet produce or handle it in a culturally appropriate manner when it is intended by the user. Using a mode thus means enabling/disabling a filter that removes or processes certain expressions that might be considered as offensive. The filter is implemented by a text processor that performs certain string matches for lexical items that are potentially rude or offensive language. If the text processor encounters such expressions, it replaces them by a beeping sound and consequently also produces a bleep in the target language, if the filter is enabled. If the strong-language filter is disabled, the expression is processed and translated and produced. Note that the filter method is a surface form method, that builds on a full processing of the content, that is, it recognizes and translates the expressions in question, and then removes or filters them, depending on user selection.

Mode dependent models: We also introduce methods that are appropriately modulating the operation of various subcomponents of a system to produce the desired result in translation. If a user speaks informally for example, such informality might be expressed in different ways in the other language. Hence, a system is trained using such conditioning modes as conditions in their training to render the correct expression more likely in a certain situation. Mode dependent models include the translation modules, the language models of the recognizer and the translator, as well as prosodic parameters and voices of the synthesis to render the pronunciation of the translation more appropriate based on mode.

### Claims:

Filters of Expressions, e.g. the rude filter

Mode dependent speech translation models, they condition the operation of the recognition, translation and synthesis components to operate in a contextually more appropriate fashion based on user intent and situation.

Modes include: informal/formal language, strong/rude vs. non-rude language, levels of emotion, commanding vs. submissive language and tone,

### Smaller Dictionary Based on User Repair and Boosting

To run on small devices it is frequently not possible to carry a large dictionary of words that provides a reasonable good coverage or a language. The proposed method circumvents this problem by building initial systems with considerably smaller dictionaries for efficiency. Coverage by contrast is then generally a problem as many common words may not be available in the systems dictionaries. To recover generality/robustness without paying the price of more memory requirements, a method is disclosed that can achieve a tighter more targeted dictionary and language model through personalization and customization of the system by the user. In this manner, the system design sacrifices only some generality of vocabularies of an overall user population, but retains the generality of vocabulary use by the individual owner and user of the device. Prior research shows, for example, that discussions between human conversant around a certain topic of interest will generally only have vocabulary sizes of about 4,000 words, while general speech translation systems may have vocabulary sizes of 40,000 words or more (in English).

In the disclosed method, the system would therefore be delivered in a state where vocabulary is more severely curtailed than in larger more general systems and thus be more parsimonious in memory use than a larger system. With vocabularies of 4,000-10,000 words, search trees, language models and pronunciation dictionaries can be reduced dramatically over vocabulary sizes of 40,000 or more. In this case, however, we will generally observe a larger mismatch between the vocabulary of the system and the desired vocabulary of the user, and out-of-vocabulary words will appear in the spoken utterances. Now, the proposed system will also come with a large background dictionary, and large pre-trained language models. This is possible without loss of advantage, since the large dictionaries and language models can be stored in flash memories that are typically available in abundance (e.g. to store music, pictures, etc.) on modem mobile phones. When an out-of-vocabulary item occurs the system now provides an easy method to correct the consequential misrecognition by various corrective mechanisms (previously disclosed). Based on the corrective action, the system now knows the user's desired word, and the system can now compare the corrected word with its internal dictionary to determine if the corrected word was just misrecognized or if it was in fact riot in the dictionary. If the word was an out-of-vocabulary item, the system performs one more check, to attempt to determine if the word was a named entity to be handled by way of named entity word classes (First Name, Last Name, CityName, etc.) used in the field customization module (already disclosed), or if it is in fact a missing open class word, such as nouns, verbs or adjectives. This determination is done by named entity tagging run on the sentence as it is presented after correction, and by checking in the background dictionary of the corrected new word appears in the background dictionary as an open-class word. Now, if the word appears in the background dictionary and the word is not a named-entity, its pronunciation entry and its pre-trained language model entry is copied from the background models and merged into the running recognition and translation models and search trees. Appropriate translations are also extracted from background phrase tables into the running speech translator. After this merging has been done, the new word will have been incorporated into the running recognition dictionary, recognition and translation language models and translation models. The system is now ready to accept the new added word for future utterances. With continuing customization the system will continue to improve and provide the user with a vocabulary that is optimized in scope, providing good coverage for his/her needs in the field, while minimal memory requirements.

### Claims:

User customization of vocabularies that are not named-entities for use in systems with small memory.
User customizable dynamic vocabulary management for open class words (not only named entities) in speech translators

### Language ID During Speech Translation

In current speech translators a user has to select a record button that pertains to the language of the speaker/user. In speech translators for two-way dialogs, this means that at least two record buttons have to be provided for the two possible language inputs. This, unfortunately, wastes screen real estate and can lead to user errors when the wrong button is pushed. In the interest of simplification, we propose to eliminate this source of user confusion, but providing automatic language identification first and then produce translation in the other language, no matter which language was spoken.

### Claims:

Speech translation using LID, this avoids having multiple buttons and activations for different languages.
   Language Learning from Speech Translation

Speech Translators today are aiming to provide two-way speech dialog communication for people who don't speak each other's languages. Frequently, though, a user may wish to learn another person's language themselves as well. To provide such possibilities, we expand the speech translator function by a language learning function. Contrary to other language learning software products, this language learner has a speech translator for language support and can provide customized language learning drills that are responding to specific user language learning interest, as it can observe a user's language usage during speech translation dialog use. Thus, a user may converse with other individuals through use of the speech translator over a period of time, and then gradually attempt to learn for him/herself key concepts, vocabularies, language constructs that he/she often uses. Thus a language learning drill can be personalized and targeted much more concretely at the specific language needs of an individual user than static impersonal language learning books or software would.

To achieve this functionality, our speech translator is expanded by a language learning module. This module observes (logs) the sentences a user has uttered over a period of time. Based on a variable window of logged user utterances, the system now builds a learning profile of typical sentence constructs and vocabularies. These will include typical syntactic constructs, as well as useful vocabularies as determined by word frequencies (commonality of words) and semantic word clustering (proximity to topic of interest). Based on this information, the system now constructs a language learning drill, that the user can invoke at will (when he/she has time) to learn.

In parallel to the automatic construction of language learning drills, the user is also provided with direct control over his/her language learning drills: each sentence spoken in the speech translator can also be directly copied to the learning module, so that its words and expressions appear in the subsequent learning drills.

### Claims:

(Human) language learning support based on speech translators. They allow a targeted, personalized language learning software support, that builds language learning drills based on a user's speech translation usage. Words that were required and used in actual operation are presented for learning.
   Speech Translation from Telephone Conversation

In the previous disclosures, we have considered speech translators for portable devices such as smart phones and PDA's. In all these deployments, the speech translator acts as a consecutive interpreter between two people in a face to face dialog situation.

We expand this notion, by using a speech translator on a telephone as an interpreter between people speaking over that telephone with each other.

To achieve this functionality, we modify the user interface. Speech is now arriving via the microphone of the user of the telephone as well as by the signal transmitted over the telephone line and is recognized and translated.

Based on this system configuration, Recognition and Translation can now be carried out in two different manners: as consecutive translation or as simultaneous translation. In the former, the user pushes a record button, as before, to accept a speech utterance either of his/her own, or from the speaker on the other end of the telephone connection. This utterance is then recognized and translated. In the case of simultaneous translation, no button is pushed but the systems attempts to translate everything on the channel. Sentences are then segmented automatically by speech segmentation and speech translation output is presented concurrently to either speaker speaking. Speech translation output is then provided either acoustically (overlaying the original speaker's speech) or visually, by displaying text on a user's telephone device.

### Claims:

Speech Translator configured to translate speech of people conversant with each other over a telephone (not face-to-face)

### Information Extraction Based on Recognized and Translated Speech

Speech Recognizers and Translators operating on a smart phone can also provide information on a user's speech content. We propose to expand the speech recognizer and translator to extract topical information from two conversants' speech. Such information is then used to seek relevant related information on the internet. Such information is then presented to the user.

There are multiple uses of such conversation enabled information extraction. It could be used to provide more targeted advertising (perhaps in return for cheaper calling rates). I could also be used to provide the user with helpful supporting information (for example, calling up flight schedules, hotel availabilities & rates, recalling a person's contact details, etc.) when a conversation mentions certain topics, people, places, or activities. This information can also be recalled bi-lingually from sources in either of the languages handled by the speech translator.

### Claims:

Extraction of information based on the content recognized and translated during speech recognition and translation of conversations.

### Back-Channeling Based on Speech Recognition and Translation

In addition to processing the word sequence obtained from a speech recognizer and translator and extracting information based on such a word sequence, we can also use prosodic cues to produce helpful or entertaining back-channeling cues. A back-channel cue is a confirmatory remark by which one dialog partner signals to the other that he/she is listening, approving, supporting, disagreeing, etc. In this manner, one person may say “u-huh”, “hmm”, “mmm”, “yes”, “right”, and so on, to signal to the other that they are still online and listening. Sometimes such back-channeling remarks also include supportive and approving remarks, such as “you are so right”, “that's a good one”, “absolutely”, or disapproving, doubting remarks, such as “well . . . ”, “really?”, and so on.

In this invention, we propose to model these cues, for speech recognizers and translators, so that a system automatically produces them based on user input. This becomes useful in speech translators, since there is typically a delay between a speaker's utterance, and the production of the translation output, thus leading to lack of confirmation by the listener. Automatic back-channeling could thus produce confirmatory cues, aimed at the speaker, to signal that communication is working and uninterrupted. Aside from aiding the communication process, automatic back-channeling can also produce an entertaining effect. We propose to expand this hack-channeling concept to include approving or disapproving remarks to the purpose of entertainment. The back-channeler is now producing approving remarks targeted at various user groups to make them feel good: “you are so great”, “why didn't I think of that?”, etc.

To achieve this functionality, the system uses in addition or apart from speech recognition, the extraction of prosodic cues, such as pauses, pitch contours, intensity, etc. The prosodic module attempts to determine suitable break-points to insert back-channel cues and/or confirmatory remarks. The break-points are determined by pauses, or by pitch deviations that indicate the end of an assertion or remark. A back-channel cue is then generated. The sensitivity of the break-point detection can also be controlled, leading to a more or less proliferous back-channeler.

### Claims:

Back-Channeling to support simultaneous speech translation. Confirmatory cues are produced to signal to a speaker that the system is still listening and producing output.
Back-Channeling as an entertaining device. Speech recognizers and translators produce back-channels that are approving or disapproving to encourage or discourage a speaker. The list of confirmatory remarks is targeted toward a specific user group (Husband, Wife, Friend, Boss, etc.)
Triggers for Back-Channeling are conditioned on prosodic cues that indicate certain speaking genres (chatting, arguing, lecturing, etc.) or discourse acts (question, statement, assertion, etc.)
Control of Back-Channeler Sensitivity

### Web Presentation Based on Speech

A simultaneous speech translator has so far been presented as a stand-alone speech translation device that produces output from a microphone speech input and output is typically presented via a overhead projector, headphones, targeted audio devices, or heads-up displays. In this invention, we describe an internet based presentation. While a lecturer makes a presentation, speech is accepted on his computer and recognized and translated either on his own computer, or on a remote computing server. The server produces output in another language that is sent to a web site that is accessible by the audience. Listeners therefore can follow a simultaneous translation over their personal computing devices, including PC's laptops, smartphones, etc., by connecting to the server. Thus lecture translation is disseminated by way of the internet without requiring any presentation tools for the simultaneous translation.

What is claimed is:

1. A method comprising:
receiving input from a user of a social networking system;
generating text corresponding to the input received from the user;
accessing a user profile of the social networking system corresponding to the user, the user profile including user profile data;
responsive to accessing the user profile, identifying, using the user profile data, a context associated with (1) the user and (2) the generated text;
selecting a translation mode from a plurality of translation modes stored in the social networking system, the selecting based on the generated text and the context associated with (1) the user and (2) the generated text; and
translating the generated text based on the selected translation mode.

2. The method of claim 1, wherein the translation mode comprises a filter for identifying a string in the translation matching a lexical item.

3. The method of claim 2, further comprising redacting the lexical item in the translation.

4. The method of claim 2, wherein the lexical item is offensive in the translation.

5. The method of claim 2, wherein the filter replaces the lexical item in the translation with a culturally appropriate phrase.

6. The method of claim 1, wherein the translation mode comprises a context-dependent translation model.

7. The method of claim 6, wherein the context-dependent model comprises an informal social situation translation model.

8. The method of claim 1, wherein the context comprises at least one of a formal social situation and an informal social situation.

9. The method of claim 1, wherein the user profile data used to determine the context includes a relationship of a correspondent communicating with the user, a time of day during which the user is corresponding with the correspondent, and a location of the user.

10. A computer program product stored on a computer-readable medium that includes instructions that, when loaded into memory, cause a processor to perform a method, the method comprising:
receiving input from a user of a social networking system;
generating text corresponding to the input received from the user;
accessing a user profile of the social networking system corresponding to the user, the user profile including user profile data;
responsive to accessing the user profile, identifying, using the user profile data, a context associated with (1) the user and (2) the generated text;
selecting a translation mode from a plurality of translation modes stored in the social networking system, the selecting based on the generated text and the context associated with (1) the user and (2) the generated text; and
translating the generated text based on the selected translation mode.

11. The method of claim 10, wherein the translation mode comprises a filter for identifying a string in the translation matching a lexical item.

12. The method of claim 11, further comprising redacting the lexical item in the translation.

13. The method of claim 11, wherein the lexical item is offensive in the translation.

14. The method of claim 11, wherein the filter replaces the lexical item in the translation with a culturally appropriate phrase.

15. The method of claim 10, wherein the translation mode comprises a context-dependent translation model.

16. The method of claim 15, wherein the context-dependent model comprises an informal social situation translation model.

17. The method of claim 1, wherein the context comprises at least one of a formal social situation and an informal social situation.

18. The method of claim 1, wherein the user profile data used to determine the context includes a relationship of a correspondent communicating with the user, a time of day during which the user is corresponding with the correspondent, and a location of the user.

19. A system comprising:
a translation module configured for:
receiving input from a user of a social networking system;
generating text corresponding to the input received from the user;
accessing a user profile stored in the social networking system corresponding to the user, the user profile including user profile data;
responsive to accessing the user profile, identifying, using the user profile data, a context associated with (1) the user and (2) the generated text;
a text processor configured for:
selecting a translation mode from a plurality of translation modes stored in the social networking system, the selecting based on the generated text and the context associated with (1) the user and (2) the generated text; and
translating the generated text based on the selected translation mode.

20. The method of claim 19, wherein the translation mode selected by the text processor comprises a filter for identifying a string in the translation matching a lexical item.

21. The method of claim 20, the text processor further configured for redacting the lexical item in the translation.

22. The method of claim 20, wherein the lexical item is offensive in the translation.

23. The method of claim 20, wherein the text processor causes the filter to replace the lexical item in the translation with a culturally appropriate phrase.

24. The method of claim 19, wherein the translation mode selected by the text processor comprises a context-dependent translation model.

25. The method of claim 24, wherein the context-dependent model comprises an informal social situation translation model.

26. The method of claim 19, wherein the context comprises at least one of a formal social situation and an informal social situation.

27. The method of claim 19, wherein the user profile data used to determine context includes a relationship of a correspondent communicating with the user, a time of day during which the user is corresponding with the correspondent, and a location of the user.
